(19) United States
(12) Patent Application Publication
(10) Pub. No.: US 2006/0136664 A1
(43) Pub. Date: Jun. 22, 2006

(54) Method, apparatus and system for disk caching in a dual boot environment

(76) Inventor: Sanjeev N. Trika, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/015,375

(22) Filed: Dec. 16, 2004

(51) Int. Cl. G06F 13/00

(52) U.S. Cl. 711/113

(57) ABSTRACT

In some embodiments, a method, apparatus and system for disk caching in a dual boot environment are presented. In this regard, a caching agent is introduced to, responsive to a system boot, read a location in non-volatile memory to determine whether a previous system boot was made into an operating system that does not support disk caching. Other embodiments are also disclosed and claimed.

### FIELD OF THE INVENTION

Embodiments of the present invention generally relate to the field of disk caching, and, more particularly to a method, apparatus and system for disk caching in a dual boot environment.

### BACKGROUND OF THE INVENTION

Mass storage devices, like hard drives, generally have large capacities and are a comparatively cheap way to store application and data files. However, mass storage devices typically have slower access times and system performance is lowered when application and data files need to be accessed from a mass storage device as opposed to a higher speed memory device. Caching is a technique whereby a smaller faster memory stores some of the application and data files from the mass storage device that might be needed soon by a processor, thereby providing faster access to the cached files. Where a non-volatile cache memory is used in a dual boot environment, there may be cache coherency issues that arise if one operating system supports disk caching while another does not.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example electronic appliance suitable for implementing the caching agent, in accordance with one example embodiment of the invention;

FIG. 2 is a block diagram of an example caching agent architecture, in accordance with one example embodiment of the invention;

FIG. 3 is a flow chart of an example method for disk caching in a dual boot environment, in accordance with one example embodiment of the invention; and

FIG. 4 is a block diagram of an example article of manufacture including content which, when accessed by a device, causes the device to implement one or more aspects of one or more embodiment(s) of the invention.

### DETAILED DESCRIPTION

FIG. 1 is a block diagram of an example electronic appliance suitable for implementing the caching agent, in accordance with one example embodiment of the invention. Electronic appliance 100 is intended to represent any of a wide variety of traditional and non-traditional electronic appliances, laptops, desktops, servers, disk drives, cell phones, wireless communication subscriber units, wireless communication telephony infrastructure elements, personal digital assistants, set-top boxes, or any electric appliance that would benefit from the teachings of the present invention. In accordance with the illustrated example embodiment, electronic appliance 100 may include one or more of processor(s) 102, memory controller 104, system memory 106, expansion controller 108, caching agent 110, storage device 112 and input/output device 114 coupled as shown in FIG. 1. Caching agent 110, as described more fully hereinafter, may well be used in electronic appliances of greater or lesser complexity than that depicted in FIG. 1. Also, the innovative attributes of caching agent 110 as described more fully hereinafter may well be embodied in any combination of hardware and software.

Processor(s) 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect.

Memory controller 104 may represent any type of chipset or control logic that interfaces system memory 106 with the other components of electronic appliance 100. In one embodiment, the connection between processor(s) 102 and memory controller 104 may be referred to as a front-side bus. In another embodiment, memory controller 104 may be referred to as a north bridge.

System memory 106 may represent any type of memory device(s) used to store data and instructions that may have been or will be used by processor(s) 102. Typically, though the invention is not limited in this respect, system memory 106 will consist of dynamic random access memory (DRAM). In one embodiment, system memory 106 may consist of Rambus DRAM (RDRAM). In another embodiment, system memory 106 may consist of double data rate synchronous DRAM (DDRSDRAM). The present invention, however, is not limited to the examples of memory mentioned here.

Expansion controller 108 may represent any type of chipset or control logic that interfaces expansion devices with the other components of electronic appliance 100. In one embodiment, expansion controller 108 may be referred to as a south bridge. In one embodiment, expansion controller 108 complies with Peripheral Component Interconnect (PCI) Express Base Specification, Revision 1.0, PCI Special Interest Group, released Apr. 29, 2002.

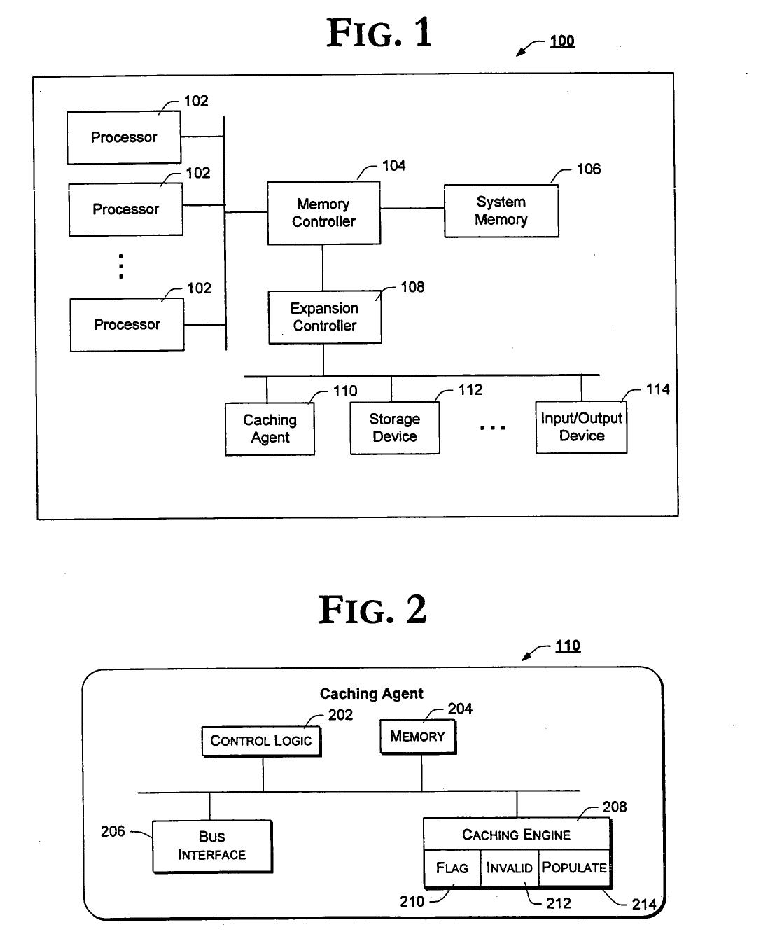

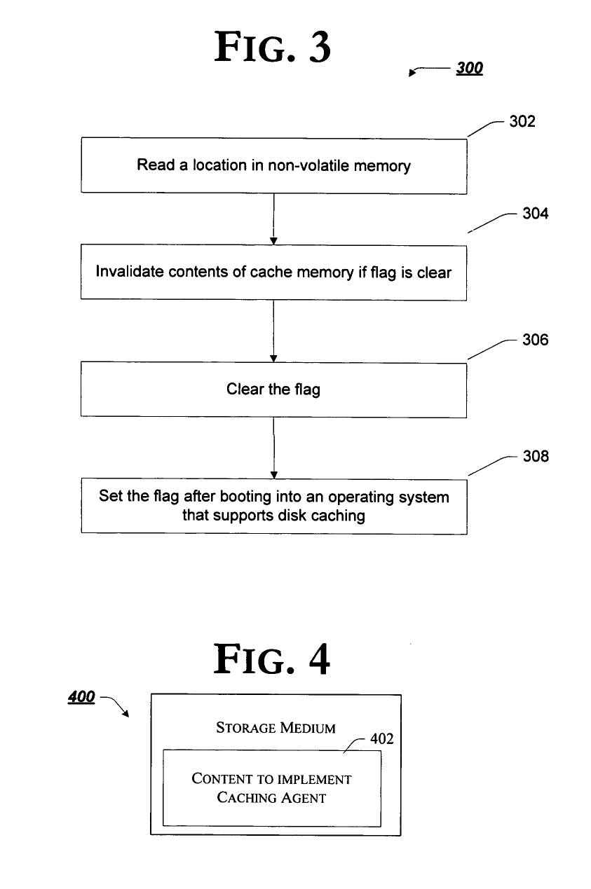

Caching agent 110 may have an architecture as described in greater detail with reference to FIG. 2. Caching agent 110 may also perform one or more methods for disk caching in a dual boot environment, such as the method described in greater detail with reference to FIG. 3. While shown as being a separate component that interfaces with electronic appliance 100 through expansion controller 108, caching agent 110 may well be part of another component, for example memory controller 104, or may be implemented in software or a combination of hardware and software.

Storage device 112 may represent any storage device used for the long term storage of data. In one embodiment, storage device 112 may be a hard disk drive. Storage device 112 may contain operating systems, which may be selectively loaded to control electronic appliance 100, including both operating systems that support disk caching and operating systems that do not support disk caching.

Input/output (I/O) device 114 may represent any type of device, peripheral or component that provides input to or processes output from electronic appliance 100. In one embodiment, though the present invention is not so limited, at I/O device 114 may be a network interface controller.

FIG. 2 is a block diagram of an example caching agent architecture, in accordance with one example embodiment of the invention. As shown, caching agent 110 may include one or more of control logic 202, memory 204, bus interface 206, and caching engine 208 coupled as shown in FIG. 2. In accordance with one aspect of the present invention, to be developed more fully below, caching agent 110 may include a caching engine 208 comprising one or more of flag services 210, invalid services 212, and/or populate services 214. It is to be appreciated that, although depicted as a number of disparate functional blocks, one or more of elements 202-214 may well be combined into one or more multi-functional blocks. Similarly, caching engine 208 may well be practiced with fewer functional blocks, i.e., with only flag services 210, without deviating from the spirit and scope of the present invention, and may well be implemented in hardware, software, firmware, or any combination thereof. In this regard, caching agent 110 in general and caching engine 208 in particular are merely illustrative of one example implementation of one aspect of the present invention. As used herein, caching agent 110 may well be embodied in hardware, software, firmware and/or any combination thereof.

Caching agent 110 may have the ability to determine whether a previous system boot was made into an operating system that supports disk caching. In one embodiment, caching agent 110 may read a location in non-volatile memory during a system boot. In another embodiment, caching agent 110 may invalidate the contents of a disk cache if the previous system boot was made into an operating system that does not support disk caching. One skilled in the art would recognize that by invalidating the disk cache in such instances would avoid potential cache coherency issues caused by the disk cache containing stale data.

As used herein control logic 202 provides the logical interface between caching agent 110 and its host electronic appliance 100. In this regard, control logic 202 may manage one or more aspects of caching agent 110 to provide a communication interface from electronic appliance 100 to software, firmware and the like, e.g., instructions being executed by processor(s) 102.

According to one aspect of the present invention, though the claims are not so limited, control logic 202 may receive event indications such as, e.g., a system boot. Upon receiving such an indication, control logic 202 may selectively invoke the resource(s) of caching engine 208. As part of an example method to accelerate application launch, as explained in greater detail with reference to FIG. 3, control logic 202 may selectively invoke flag services 210 that may read and maintain a flag to determine if the previous system boot was made into an operating system that supports disk caching. Control logic 202 also may selectively invoke invalid services 212 or populate services 214, as explained in greater detail with reference to FIG. 3, to invalidate the contents of a non-volatile disk cache or to populate and utilize the non-volatile disk cache, respectively. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In some implementations, control logic 202 is intended to represent content (e.g., software instructions. etc.), which when executed implements the features of control logic 202 described herein.

Memory 204 is intended to represent any of a wide variety of memory devices and/or systems known in the art. According to one example implementation, though the claims are not so limited, memory 204 may well include volatile and non-volatile memory elements, possibly random access memory (RAM) and/or read only memory (ROM). Memory 204 may also include, among others: polymer memory, battery backed DRAM, RDRAM, NAND/NOR memory, flash memory, or Ovonics memory. In one embodiment, memory 204 may be a portion of system memory 106. In another embodiment, memory 204 may be part of a processor, system disk, or network cache. Memory 204 may be used to store a flag to indicate whether electronic appliance 100 was booted into an operating system that supports disk caching. Memory 204 may also be used to store files needed to launch an application, such as executable and dynamic link library files, for example. In this way memory 204 may function as a non-volatile disk cache that is capable of retaining its contents even when electronic appliance 100 is unpowered.

Bus interface 206 provides a path through which caching agent 110 can communicate with other components of electronic appliance 100, for example storage device 112 or I/O device 114. In one embodiment, bus interface 206 may represent a PCI Express interface.

As introduced above, caching engine 208 may be selectively invoked by control logic 202 to read and maintain a flag to determine if the previous system boot was made into an operating system that supports disk caching, to invalidate the contents of a non-volatile disk cache, or to populate and utilize the non-volatile disk cache. In accordance with the illustrated example implementation of FIG. 2, caching engine 208 is depicted comprising one or more of flag services 210, invalid services 212 and populate services 214. Although depicted as a number of disparate elements, those skilled in the art will appreciate that one or more elements 210-214 of caching engine 208 may well be combined without deviating from the scope and spirit of the present invention.

Flag services 210, as introduced above, may provide caching agent 110 with the ability to read and maintain a flag to determine if the previous system boot was made into an operating system that supports disk caching. In one example embodiment, flag services 210 may read a location in memory 204. In another example embodiment, caching engine 208 invokes invalid services 212 if flag services 210 determines that the memory location (or flag) is clear. Flag services 210 may also clear the flag, if it were set, before an operating system is loaded. Flag services 210 may also set the flag if a disk cache driver is loaded within an operating system that supports disk caching, so that the contents of disk cache would not be invalidated on the next system boot.

As introduced above, invalid services 212 may provide caching agent 110 with the ability to invalidate the contents of a non-volatile disk cache. In one example embodiment, invalid services 212 may clear the contents of the disk cache. In another example embodiment, invalid services 212 may set one or more bits within the disk cache which the disk cache drive would understand to mean the current contents are stale and should be overwritten.

Populate services 214, as introduced above, may provide caching agent 110 with the ability to populate and utilize the non-volatile disk cache. In one embodiment, populate services 214 may be accessed by a disk cache driver to load content from storage device 112 into memory 204 as part of a disk cache method. In another example embodiment, populate services 214 may provide disk cache content stored in memory 204 to processor(s) 102 as part of a method to accelerate system performance. Because populate services 214 would only be invoked from within an operating system that supports disk caching, populate services 214 may set the flag in memory 204 to indicate that electronic appliance 100 was booted into an operating system that supports disk caching.

FIG. 3 is a flow chart of an example method for disk caching in a dual boot environment, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

According to but one example implementation, the method of FIG. 3 begins with control logic 202 selectively invoking flag services 210 to read (302) a location in non-volatile memory. In one example embodiment, flag services 210 reads a flag stored in memory 204. In another example embodiment, whether a particular bit is set to one will enable flag services 210 to determine whether the previous system boot was made into an operating system that supports disk caching.

Control logic 202 may then selectively invoke invalid services 212 to invalidate (304) contents of cache memory if the flag is clear. In one example embodiment, invalid services 212 may clear the contents of a disk cache. In another example embodiment, invalid services 212 may set one or more bits which the disk cache driver would interpret to mean the data is unusable and should be overwritten.

Next, flag services 210 may clear (306) the flag. In one embodiment, flag services clears the flag if it were set, so that if the present system boot is made into an operating system that does not support disk caching, caching engine 208 would be able to invalidate the contents of disk cache on the next system boot to avoid cache coherency problems.

Control logic 202 may then selectively invoke populate services 214 to set (308) the flag after booting into an operating system that supports disk caching. In one embodiment, populate services 214 may be invoked by a device driver from within an operating system that supports disk caching. In this way, caching engine 208 will be able to determine that the contents of the disk cache should not be invalidated on the next system boot.

FIG. 4 illustrates a block diagram of an example storage medium comprising content which, when accessed, causes an electronic appliance to implement one or more aspects of the caching agent 110 and/or associated method 300. In this regard, storage medium 400 includes content 402 (e.g., instructions, data, or any combination thereof) which, when executed, causes the appliance to implement one or more aspects of caching agent 110, described above.

The machine-readable (storage) medium 400 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the present invention may be used in a variety of applications. Although the present invention is not limited in this respect, the invention disclosed herein may be used in microcontrollers, general-purpose microprocessors, Digital Signal Processors (DSPs), Reduced Instruction-Set Computing (RISC), Complex Instruction-Set Computing (CISC), disk drives, computers, among other electronic components. However, it should be understood that the scope of the present invention is not limited to these examples.

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
responsive to a system boot, reading a location in memory to determine whether a previous system boot was made into an operating system that supports disk caching.

2. The method of claim 1, wherein the location in memory comprises a flag.

3. The method of claim 2, further comprising:
invalidating a disk cache if the flag is clear.

4. The method of claim 3, further comprising:
clearing the flag.

5. The method of claim 4, further comprising:
setting the flag after booting into an operating system that supports dick caching.

6. The method of claim 4, wherein the disk cache comprises memory selected from the group consisting of polymer memory, flash memory, Ovonics memory and DRAM memory.

7. An electronic appliance, comprising:
a processor;
a cache memory coupled with the processor to store data needed for the launch of an application;
a storage device coupled with the cache memory; and
a caching engine coupled with cache memory, the caching engine to, responsive to a system boot, read a location in memory to determine whether a previous system boot was made into an operating system that supports disk caching.

8. The electronic appliance of claim 7, wherein the location in memory comprises a flag.

9. The electronic appliance of claim 8, further comprising:
the caching engine to invalidate contents of the cache memory if the flag is clear.

10. The electronic appliance of claim 9, further comprising:
the caching engine to clear the flag.

11. The electronic appliance of claim 10, further comprising:
the caching engine to set the flag after booting into an operating system that supports disk caching.

12. The electronic appliance of claim 10, wherein the cache memory comprises memory selected from the group consisting of polymer memory, flash memory, Ovonics memory and DRAM memory.

13. A storage medium comprising content which, when executed by an accessing machine, causes the accessing machine to read a flag in memory to determine whether a previous system boot was made into an operating system that does not support disk caching and to invalidate a disk cache if the flag is clear.

14. The storage medium of claim 13, further comprising content which, when executed by the accessing machine, causes the accessing machine to clear the flag.

15. The storage medium of claim 14, further comprising content which, when executed by the accessing machine, causes the accessing machine to set the flag after booting into an operating system that supports disk caching.

16. The storage medium of claim 15, further comprising content which, when executed by the accessing machine, causes the accessing machine to populate the disk cache according to a caching scheme.

17. The storage medium of claim 15, further comprising content which, when executed by the accessing machine, causes the accessing machine to write through the contents of the disk cache to a storage device.

18. An apparatus, comprising:
cache memory;
a bus interface; and
control logic coupled with the bus interface and the cache memory, the control logic to read a flag in the cache memory to determine whether a previous system boot was made into an operating system that does not support disk caching.

19. The apparatus of claim 18, further comprising control logic to invalidate contents of the cache memory if the flag is clear.

20. The apparatus of claim 19, further comprising control logic to clear the flag.

21. The apparatus of claim 20, further comprising control logic to set the flag after booting into an operating system that supports disk caching.

22. The apparatus of claim 20, wherein the cache memory comprises memory selected from the group consisting of polymer memory, flash memory, Ovonics memory and DRAM memory.
